(19) United States
(12) Patent Application Publication
(10) Pub. No.: US 2002/0185627 A1
(43) Pub. Date: Dec. 12, 2002

(54) Solid composite polymer electrolyte

(75) Inventors: Yui-Whei Chen-Yang, Hsinchu (TW); Hung-Chang Chen, Chiayi Hsien (TW); Fu-Luo Lin, Taichung Hsien (TW)

Correspondence Address: MORGAN, LEWIS & BOCKIUS LLP, 1800 M Street, N. W., Washington, DC, 20036-5869, US

(73) Assignee: Chung Yuan Christian University

(21) Appl. No.: 09/865,478

(22) Filed: May 29, 2001

(51) Int. Cl. H01G 2/00; H01M 6/18

(52) U.S. Cl. 252/62.2; 429/306; 429/323

(57) ABSTRACT

A solid composite polymer electrolyte contains a general amorphous branched polymer having recurrent units, each of which includes a backbone chain and at least a side chain linked to the backbone chain and containing at least one coordination potential atom, an amphoteric metal salt dispersed in the branched polymer and forming Lewis acid-base interactions with the side chains, and an amphoteric Lewis acid-base ceramic filler dispersed in the branched polymer and forming Lewis acid-base interactions with the side chains and the metal salt.

### BACKGROUND OF THE INVENTION

1. Field of the Invention

This invention relates to a solid composite polymer electrolyte, more particularly to a solid composite polymer electrolyte having a branched polymer that has recurrent units, each of which includes a backbone chain and at least a side chain which is linked to the backbone chain and which contains at least one coordination potential atom.

2. Description of the Related Art

Since the early 1970s, polymer electrolytes has attracted many researchers due to the possibility of its application to various electrochemical devices, such as batteries, electrochromic windows, displays and fuel cells. Many polymeric electrolytes have been reported and they may be divided into three categories, dry solid type, gel-type and composite type. The dry solid type polymer electrolytes presently show lower ionic conductivity (˜10⁻⁵ Scm⁻¹ at room temperature) but are less harmful to the environment. While the gel-type polymer electrolytes have higher ionic conductivities (˜10⁻³ Scm⁻¹ at room temperature), they are hazardous due to the incorporated organic solvent. The composite type, a subset of the solid electrolytes, is usually called composite polymer electrolytes. Due to the presence of ceramic fillers, such as Al₂O₃, TiO₂ etc., the composite polymer electrolytes usually show a higher ionic conductivity, a better mechanical property, and electrolyte-metal electrode interfacial stability.

During the past years, most research on composite polymer electrolytes have focused on polyether-based matrices, especially on polyether oxide (PEO) composite electrolytes. The effect of ceramic fillers and salt concentration on the conductivity, transport number and electrode-electrolyte interfacial interaction of PEO-based composite electrolytes has been investigated and reviewed. The conductivity enhancement by addition of the ceramic fillers has been attributed mainly to the decreased crystallinity of the PEO-based polymer matrix.

On the other hand, the poly[bis(methoxyethoxy ethoxy)phosphazene] (MEEP)/lithium salt electrolytes system showed higher conductivity (1.7×10⁻⁵ Scm⁻¹at room temperature) than the corresponding PEO-lithium salt electrolyte system (˜10⁻⁸ Scm⁻¹ at 20° C.). However, poor mechanical stability is a shortcoming for practical application. Therefore, many efforts, which include the cross-linking of MEEP, the chemical cross-linking of MEEP with poly(ethylene glycol), the Co α irradiation of ether MEEP or MEEP-(LiX)_{0.25} complexes, or the use of a porous, fiberglass matrix to support MEEP have been proposed to solve this problem. The best conductivities of these electrolyte systems are in the range of 1.0×10⁻⁵ to 7.0×10⁻⁵ Scm⁻¹ at room temperature. Nevertheless, an increase in mechanical stability is usually paid off by a decrease in conductivity.

Recently, there has been proposed structured polymer electrolytes that can lead to enhanced ionic conductivity. However, the enhancement is still limited.

Accordingly, the conduction mechanism in polymer electrolytes is relatively complex, and there remains a need for the improvement of the conductivity of the polymer electrolyte.

### SUMMARY OF THE INVENTION

Therefore, it is an object of the present invention to provide a solid composite polymer electrolyte with good mechanical property and high conductivity at room temperature.

Accordingly, the solid composite polymer electrolyte of the present invention comprises: a general amorphous branched polymer having recurrent units, each of which includes a backbone chain and at least a side chain linked to the backbone chain, the side chain containing at least one coordination potential atom; an amphoteric metal salt dispersed in the branched polymer and in Lewis acid-base interaction with the side chains; and an amphoteric Lewis acid-base ceramic filler dispersed in the branched polymer and forming Lewis acid-base interaction with the side chains and the metal salt.

### DETAILED DESCRIPTION OF THE PREFERRED EMBODIMENTS

The inventors have found that, in contrast with the teaching of the aforesaid reduction of the crystallinity of the PEO-based polymer matrix by the addition of ceramic fillers, the conductivity of the polymer electrolyte can be significantly enhanced when the polymer electrolyte contains a general amorphous branched polymer having recurrent units, each of which includes a backbone chain and at least a side chain linked to the backbone chain and containing at least one coordination potential atom, an amphoteric metal salt dispersed in the branched polymer and forming Lewis acid-base interactions with the side chains, and an amphoteric Lewis acid-base ceramic filler dispersed in the branched polymer and forming Lewis acid-base interactions with the side chains and the metal salt. The aforesaid general amorphous branched polymer is defined herein as a branched polymer that is completely amorphous or that can be considered as amorphous with partially microcrystalline domains.

For the ceramic-free polymer electrolyte, there is only one Lewis acid-base interaction between the metal ion of the metal salt and the coordination potential atom. On the other hand, for the ceramic-containing polymer electrolyte, there are three Lewis acid-base interactions among the metal ion of the metal salt, the coordination potential atom, and the ceramic filler. As a consequence, the addition of the ceramic filler provides extra paths for the metal ion transport in the polymer electrolyte, and thus greatly enhances the conductivity of the polymer electrolyte. Moreover, the enhancement of the conductivity is extended over a larger concentration range for the ceramic-containing polymer electrolyte than that for the ceramic-free polymer electrolyte.

In a preferred embodiment, the backbone chain of the branched polymer is selected from a group consisting of a —P═N— group and a —C—C— group, whereas the coordination potential atom of the side chain is selected from a group consisting of an alkoxy group and a C≡N group. Preferably, when the backbone chain of the branched polymer is a —P═N— group, the side chain is an alkoxy group, and when the backbone chain of the branched polymer is a —C—C— group, the side chain is a C≡N group. More preferably, the branched polymer is selected from a group consisitng of poly[bis(methoxy ethoxyethoxy)phosphazene] and polyacrylonitrile.

Preferably, the ceramic filler is made from a material selected from a group consisting of α-Al₂O₃, TiO₂, SiO₂, MgO, and BaTiO₃.

Preferably, the metal salt is a lithium salt selected from a group consisting of lithium perchlorate, LiI, LiCF₃SO₃, LiN(CF₃SO₃)₂, and LiPF₆.

In another preferred embodiment, the branched polymer is poly[bis(methoxy ethoxyethoxy)phosphazene] having a molecular weight ranging from about 1000 to about 10⁶, the ceramic filler is made from α-Al₂O₃, and the solid composite polymer electrolyte comprises 86 to 95% by weight of poly[bis(methoxy ethoxyethoxy)phosphazene], 4 to 9% by weight of lithium perchlorate, and 1 to 5% by weight of α-Al₂O₃, preferably, 90 to 92.5% by weight of poly[bis(methoxy ethoxyethoxy)phosphazene], 5.5 to 7% by weight of lithium perchlorate (LiClO₄), and 2 to 3% by weight of α-Al₂O₃. When the weight of α-Al₂O₃ is lower than 1 wt %, the conductivity enhancement is relatively poor, and when the weight is greater than 5 wt %, formation of aggregates of the α-Al₂O₃ occurs, thereby greatly reducing the conductivity.

In yet another preferred embodiment, the branched polymer is polyacrylonitrile (PAN) having a molecular weight ranging from about 10000 to about 10⁷, and the solid composite polymer electrolyte comprises 41 to 70% by weight of polyacrylonitrile, 27 to 50% by weight of lithium perchlorate, and 3 to 9% by weight of the ceramic filler, preferably, 47 to 60% by weight of polyacrylonitrile, 35 to 45% by weight of lithium perchlorate, and 5 to 8% by weight of the ceramic filler. For the PAN/LiO₄/α-Al₂O₃ electrolyte system, when the weight of α-Al₂O₃ is lower than 3 wt %, the conductivity enhancement is relatively poor, and when the weight is greater than 9 wt %, formation of aggregates of the α-Al₂O₃ particles occurs, thereby greatly reducing the conductivity. For the PAN/LiO₄/TiO₂ electrolyte system, when the weight of TiO₂ is lower than 3 wt %, the conductivity enhancement is relatively poor, and when the weight is greater than 9 wt %, formation of aggregates of the TiO₂ particles occurs, thereby greatly reducing the conductivity.

Preferably, the PAN-based solid composite polymer electrolyte further comprises a residual solvent which can enhance extentability of the solid composite polymer electrolyte. The solvent is selected from a group consisting of DMF (dimethylformamide), ethylene carbonate (EC), propylene carbonate (PC), and the like.

Preferably, the ceramic filler employed in the composite polymer electrolyte of this invention has a particle size less than 150 microns.

Having the general nature of the invention set forth above, the following Examples and Comparative Examples are presented in order that the invention may be more readily understood.

### EXAMPLES 1 to 18 AND COMPARATIVE EXAMPLES 1 to 6

A. Materials

Hexachlorocyclotriphosphazene was obtained from the Nippon Fine Chemical Corp, Japan. Methoxyethoxyethanol was purchased from Merck Chemical Co. Lithium perchlorate (LiClO₄), tetrahydrofuran (THF), n-hexane, sulfur (S₈), sodium hydride (NaH) and methanol were purchased from Aldrich Chemical Co. α-Al₂O₃ (100 nm) was obtained from the Grace Derwey Co. LTD. LiClO₄ and α-Al₂O₃ were vacuum dried (<10⁻⁴ torr) for 24 hours at 120° C. prior to use, and the THF was distilled under nitrogen from sodium benzophenone before use.

B. Synthesis of Poly[Dichlorophosphazene]

Hexachlorocyclotriphosphazene, (NPCl₂)₃, (50.0 g) and sulfur (5.0 g), used as a catalyst, were weighed directly into a Pyrex ampule. The ampule was evacuated to 0.05 Torr for 1 hour and then sealed. The sealed ampule was placed in a furnace and heated to 285° C. until the melting mixture became highly viscous but still slightly mobile. The ampule was opened, and the contents were extracted with dry benzene to remove the cross-linked polymer. The product, linear polymer (NPCl₂)n, was then purified by precipitation from a benzene solution into n-hexane. An average of 50-60% conversion to the linear polymer was obtained.

C. Synthesis of Poly[Bis(Methoxyethoxyethoxy)Phosphazene], (MEEP)

A solution of 2-(2-methoxyethoxyethanol (64.8g, 0.54 mol) was added to sodium hydride (13.0g, 0.54 mole) in dry THF (1000 ml). Once the sodium had reacted completely, the solution was treated with a solution of poly(dichlorophosphazene) (25.0 g, 0.216 unit mole) in the dry THF (600 mL) under nitrogen atmosphere. The reaction mixture was dialyzed (MWCO: 12-14000) against water (2 weeks) The residual solvent was finally removed by drying under a vacuum to give a polymer product (36.6 g, 60% yield). Analysis of MEEP by gel permeation chromatography (GPC) revealed a number average molecular weight Mn=7.29×10⁴ and a polydispersity index (PDI=Mw/Mn) of 1.44.

D. Preparation of Polymer Electrolytes

The concentration of the metal salt is expressed as the mole ratio of the metal salt fed to a polyphosphazene repeat unit (PN), F=[metal salt]/[PN]. In order to prepare the electrolytes, appropriate amounts of MEEP were dissolved in a small amount of anhydrous THF, and after the addition of the required quantity of the corresponding metal salt, the solution was well stirred. The composite electrolytes were obtained by dispersing the designed amount of ceramic filler in the MEEP/metal salt solutions. The solutions were stirred for 24 hours, and were subsequently dried in a vacuum oven at 65° C. for at least 24 hours. The dried samples were stored in an argon-filled glovebox to avoid contamination before measurements. Throughout this specification, abbreviations will be used to identify the different polymer electrolytes. In MFxAy, M represents MEEP, F represents metal salt concentration (F2 means F=0.2), A represents ceramic filler, and y is the wt % of the ceramic filler based on the polymer electrolyte. The metal salt and the ceramic filler employed in the Examples are respectively lithium perchlorate (LiClO₄) and α-Al₂O₃.

E. Conductivity Measurement

The ionic conductivities of the polymer electrolytes were measured by a complex impedance method in the temperature range of from 30 to 80° C. The samples were sandwiched between stainless steel blocking electrodes and placed in a temperature-controlled oven at vacuum (<10⁻² torr) for 2 hours before measurement. The experiments were performed in a cylindrical cell with an electrode diameter equal to 0.785 cm². Each electrolyte sample, which is to be measured, has a thickness equal to 0.1 mm. The impedance measurements were carried out on a computer-interfaced HP 4192A impedance analyzer over the frequency range 5 Hz to 13 MHz.

F. Results

The conductivities of the polymer electrolytes prepared in Examples 1 to 18 and Comparative Examples 1 to 6 (ceramic-free electrolytes) are listed in Table 1.

TABLE 1

| | | Measured | Conductivity |
|---|---|---|---|
| Examples | MFxAy | temperature, ° C. | Scm⁻¹ |
| 1 | MF1A1.25 | 30 | 6.35 × 10⁻⁵ |
| 2 | MF1A2.5 | 30 | 9.36 × 10⁻⁵ |
| 3 | MF1A5 | 30 | 5.27 × 10⁻⁵ |
| 4 | MF2A1.25 | 30 | 7.94 × 10⁻⁵ |
| 5 | MF2A2.5 | 30 | 9.70 × 10⁻⁵ |
| 6 | MF2A5 | 30 | 7.57 × 10⁻⁵ |
| 7 | MF25A1.25 | 30 | 6.83 × 10⁻⁵ |
| 8 | MF25A2.5 | 30 | 9.02 × 10⁻⁵ |
| 9 | MF25A5 | 30 | 5.33 × 10⁻⁵ |
| 10 | MF2A1.25 | 50 | 8.13 × 10⁻⁵ |
| 11 | MF2A2.5 | 50 | 1.0 × 10⁻⁴ |
| 12 | MF2A5 | 50 | 1.04 × 10⁻⁴ |
| 13 | MF2A1.25 | 60 | 8.91 × 10⁻⁵ |
| 14 | MF2A2.5 | 60 | 1.18 × 10⁻⁴ |
| 15 | MF2A5 | 60 | 1.18 × 10⁻⁴ |
| 16 | MF2A1.25 | 80 | 1.0 × 10⁻⁴ |
| 17 | MF2A2.5 | 80 | 1.39 × 10⁻⁴ |
| 18 | MF2A5 | 80 | 1.47 × 10⁻⁵ |
| Comparative | MF1A0 | 30 | 4.69 × 10⁻⁵ |
| Example 1 | | | |
| Comparative | MF2A0 | 30 | 6.51 × 10⁻⁵ |
| Example 2 | | | |
| Comparative | MF25A0 | 30 | 5.80 × 10⁻⁵ |
| Example 3 | | | |
| Comparative | MF2A0 | 50 | 7.61 × 10⁻⁵ |
| Example 4 | | | |
| Comparative | MF2A0 | 60 | 8.64 × 10⁻⁵ |
| Example 5 | | | |
| Comparative | MF2A0 | 80 | 9.62 × 10⁻⁵ |
| Example 6 | | | |

As listed in Table 1 the conductivities of the electrolytes measured at 30° C. vary with the concentration of the lithium salt and the amounts of the α-Al₂O₃ added. The change in the conductivity is a function of the lithium salt concentration for the MEEP/LiClO₄ electrolytes with or without α-Al₂O₃. For the MEEP/LiClO₄ system without α-Al₂O₃, the ionic conductivity initially increases with an increasing metal salt concentration due to the increase in the number of charge carriers, and reaches a maximum at F value of 0.2. Beyond this point, the number of ionic cross-links restricts motion of ethyleneoxy side groups of MEEP, and fewer sites in the right position for coordination with lithium are available to assist the ion-pair separation, thereby reducing the ionic conductivity. On the other hand, with the addition of α-Al₂O₃, the MEEP/LiClO₄/α-Al₂O₃ composite electrolytes have a higher ionic conductivity than the corresponding MEEP/LiClO₄ electrolytes. Maximum conductivities also occur at F=0.2 for all the α-Al₂O₃ containing composite polymer electrolytes. The best conductivity obtained from the one with 2.5 wt % α-Al₂O₃ and F=0.2 is close to 10⁻⁴ S/cm at 30° C. This is about twice that of the pristine polymer electrolyte and is the highest value found at ambient temperature for phosphazene polymer electrolytes. It is also noticed that a significant conductivity enhancement of MEEP/LiClO₄ is found only over a narrow salt concentration range (F=0.2), while the enhancement of the composite electrolyte system with 2.5 wt % α-Al₂O₃ is extended over a larger metal salt concentration region (F=0.1 to 0.25). Such behavior may be associated with the lithium ion transport mechanism which is closely related to the interactions among the polymer, the lithium salt and the ceramic filler.

Besides, with the same content of lithium salt, the conductivity of the composite electrolyte increases with increasing α-Al₂O₃ content, reaches a maximum for the sample with 2.5 wt % of α-Al₂O₃, and then decreases for electrolytes with higher α-Al₂O₃ concentration. This result implies that α-Al₂O₃plays an important role in the ion transport mechanism in this composite polymer electrolyte system.

Moreover, the conductivities of the composite electrolytes with 2.5 wt % α-Al₂O₃ remain consistently higher than those of the α-Al₂O₃— free electrolytes in the range of 30° C.-80° C.

### EXAMPLES 19 to 49

A. Materials

Polyacrylonitrile (PAN, Mw: 150,000, Sp²), lithium perchlorate (LiClO₄) (Acros, reagent grade) and N, N-dimethylformamide (DMF) were purchased from Aldrich Co. . α-Al₂O₃ (100 nm) was obtained from the Grace Derwey CO. LTD. The average particle size for TiO₂ is about 5 microns. LiClO₄ and α-Al₂O₃ were vacuum dried (<10⁻³ torr) for 24 hours at 140° C. prior to use.

B. Preparation of Polymer Electrolytes

The concentration of the metal salt is expressed as the molar ratio of the metal salt fed to a polyacryloritrile repeating unit, F=(metal salt)/(CN). To prepare the electrolyte, an appropriate amount of PAN was first dissolved with a small amount of DMF. Then, the required quantity (F value) of the metal salt was added, and the solution was stirred. A designed amount of ceramic filler powder was then added, and the PAN/metal salt/filler solution was stirred continuously by a high-intensity ultrasonic finger directly immersed in the solution for 24 hours to break down the particles. Thereafter, the solution was cast on a flat glass and dried in a vacuum oven at a proper temperature to remove the solvent for at least 24 hours and then taken out to cool to room temperature. The mechanically stable membranes obtained have an average thickness of about 100 μm. The DMF residue in the membranes estimated from TGA-IR measurement was less than 10 wt %. The dried samples were stored in an argon-filled glovebox (water is less than 5 ppm) to avoid moisture contamination. Throughout this specification, abbreviations will be used to identify the different composite polymer electrolytes. For NFxAy, N represents PAN, Fx represents the metal salt concentration (F2 means F=0.2), A represents the ceramic filler and y is the wt % of the ceramic filler in the electrolyte. The metal salt employed in the Examples is lithium perchlorate (LiClO₄) The ceramic filler employed in Examples 19-37 is α-Al₂O₃, and in Examples 38-49 is TiO₂.

C. Conductivity Measurement

The ionic conductivities of the polymer electrolytes were measured by the aforesaid complex impedance method at a temperature of 30° C.

D. Results

The conductivities of the polymer electrolytes prepared in Examples 19 to 49 are listed in Table 2.

TABLE 2

| | NFxAy | Measured | Conductivity |
|---|---|---|---|
| Examples | A = α − Al₂O₃ | temperature, ° C. | Scm⁻¹ |
| 19 | NF2A3.8 | 30 | 8.3 × 10⁻⁸ |
| 20 | NF2A5 | 30 | 1.9 × 10⁻⁷ |
| 21 | NF2A7.5 | 30 | 9.8 × 10⁻⁸ |
| 22 | NF3A3.8 | 30 | 9.9 × 10⁻⁶ |
| 23 | NF3A5 | 30 | 1.0 × 10⁻⁶ |
| 24 | NF3A7.5 | 30 | 5.3 × 10⁻⁶ |
| 25 | NF3A10 | 30 | 1.6 × 10⁻⁵ |
| 26 | NF4A3.8 | 30 | 2.0 × 10⁻⁵ |
| 27 | NF4A5 | 30 | 5.2 × 10⁻⁵ |
| 28 | NF4A7.5 | 30 | 2.8 × 10⁻⁵ |
| 29 | NF4A10 | 30 | 1.5 × 10⁻⁵ |
| 30 | NF5A3.8 | 30 | 1.1 × 10⁻⁴ |
| 31 | NF5A5 | 30 | 2.1 × 10⁻⁵ |
| 32 | NF5A7.5 | 30 | 1.3 × 10⁻⁴ |
| 33 | NFSA10 | 30 | 1.6 × 10⁻⁵ |
| 34 | NF6A3.8 | 30 | 1.8 × 10⁻⁴ |
| 35 | NF6A5 | 30 | 3.4 × 10⁻⁴ |
| 36 | NF6A7.5 | 30 | 5.7 × 10⁻⁴ |
| 37 | NF6A10 | 30 | 2.7 × 10⁻⁴ |
| | NFxAy | Measured | Conductivity |
| Examples | A = TiO₂ | temperature, ° C. | Scm⁻¹ |
| 38 | NF3A3.8 | 30 | 2.8 × 10⁻⁶ |
| 39 | NF3A5 | 30 | 5.9 × 10⁻⁶ |
| 40 | NF3A7.5 | 30 | 1.7 × 10⁻⁵ |
| 41 | NF4A3.8 | 30 | 2.8 × 10⁻⁶ |
| 42 | NF4A5 | 30 | 7.3 × 10⁻⁵ |
| 43 | NF4A7.5 | 30 | 6.0 × 10⁻⁵ |
| 44 | NF5A3.8 | 30 | 8.6 × 10⁻⁵ |
| 45 | NF5A5 | 30 | 2.1 × 10⁻⁵ |
| 46 | NF5A7.5 | 30 | 1.3 × 10⁻⁴ |
| 47 | NF6A3.8 | 30 | 7.4 × 10⁻⁵ |
| 48 | NF6A5 | 30 | 2.7 × 10⁻⁴ |
| 49 | NF6A7.5 | 30 | 2.4 × 10⁻⁴ |

Similar to the MEEP/LiClO₄/α-Al₂O₃ composite electrolytes prepared in Examples 1 to 18, the conductivities of the electrolytes PAN/LiO4/TiO₂ or α-Al₂O₃ prepared in Examples 19-49 measured at 30° C. also vary with the concentration of the lithium salt and the amounts of the ceramic filler added. Such conductivity enhancement also closely relates to the extra paths of the lithium ion transport resulted from effective Lewis acid-base interactions among the PAN polymer, the lithium salt and the ceramic filler.

With the invention thus explained, it is apparent that various modifications and variations can be made without departing from the spirit of the present invention.

We claim:

1. A solid composite polymer electrolyte comprising:
a general amorphous branched polymer having recurrent units, each of which includes a backbone chain and at least a side chain linked to said backbone chain and containing at least one coordination potential atom;
an amphoteric metal salt dispersed in said branched polymer and forming Lewis acid-base interactions with said side chains; and
an amphoteric Lewis acid-base ceramic filler dispersed in said branched polymer and forming Lewis acid-base interactions with said side chains and said metal salt.

2. The solid composite polymer electrolyte of claim 1, wherein said backbone chain of said branched polymer is selected from a group consisting of a —P═N— group and a —C—C— group, and said coordination potential atom of said side chain is selected from a group consisting of an alkoxy group and a C≡N group.

3. The solid composite polymer electrolyte of claim 2, wherein said backbone chain of said branched polymer is a —P═N— group, and said coordination potential atom of said side chain is an alkoxy group.

4. The solid composite polymer electrolyte of claim 3, wherein said branched polymer is poly[bis(methoxy ethoxyethoxy)phosphazene] having a molecular weight ranging from about 1000 to about 10⁶.

5. The solid composite polymer electrolyte of claim 2, wherein said backbone chain of said branched polymer is a —C—C— group, and said coordination potential atom of said side chain is a C≡N group.

6. The solid composite polymer electrolyte of claim 5, wherein said branched polymer is polyacrylonitrile having a molecular weight ranging from about 10000 to about 10⁷.

7. The solid composite polymer electrolyte of claim 2, wherein said ceramic filler is made from a material selected from a group consisting of α-Al₂O₃ and TiO₂.

8. The solid composite polymer electrolyte of claim 7, wherein said metal salt is a lithium salt.

9. The solid composite polymer electrolyte of claim 8, wherein said lithium salt is lithium perchlorate.

10. The solid composite polymer electrolyte of claim 9, wherein said branched polymer is poly[bis(methoxy ethoxyethoxy)phosphazene], and said ceramic filler is made from α-Al₂O₃, said solid composite polymer electrolyte comprising 86 to 95% by weight of poly[bis(methoxy ethoxyethoxy)phosphazene], 4 to 9% by weight of lithium perchlorate, and 1 to 5% by weight of α-Al₂O₃.

11. The solid composite polymer electrolyte of claim 10, comprising 90 to 92.5% by weight of poly[bis(methoxy ethoxyethoxy)phosphazene], 5.5 to 7% by weight of lithium perchlorate, and 2 to 3% by weight of α-Al₂O₃.

12. The solid composite polymer electrolyte of claim 9, wherein said branched polymer is polyacrylonitrile, said solid composite polymer electrolyte comprising 41 to 70% by weight of polyacrylonitrile, 27 to 50% by weight of lithium perchlorate, and 3 to 9% by weight of said ceramic filler.

13. The solid composite polymer electrolyte of claim 12, comprising 47 to 60% by weight of polyacrylonitrile, 35 to 45% by weight of lithium perchlorate, and 5 to 8% by weight of said ceramic filler.

14. The solid composite polymer electrolyte of claim 7, wherein said ceramic filler has a particle size less than 150 microns.
